(19) United States
(12) Patent Application Publication
(10) Pub. No.: US 2025/0156221 A1
(43) Pub. Date: May 15, 2025

(54) TASK SCHEDULING METHOD AND APPARATUS, AND TERMINAL DEVICE AND STORAGE MEDIUM

(71) Applicant: HUIZHOU TCL MOBILE COMMUNICATION CO., LTD., Huizhou, Guangdong (CN)

(72) Inventor: Wu YAN, Huizhou, Guangdong (CN)

(73) Assignee: HUIZHOU TCL MOBILE COMMUNICATION CO., LTD., Huizhou, Guangdong (CN)

(21) Appl. No.: 18/832,949

(22) PCT Filed: Jan. 3, 2023
(86) PCT No.: PCT/CN2023/070099

§ 371 Date: Jul. 25, 2024

(30) Foreign Application Priority Data
Jan. 25, 2022 (CN) 202210099278.3

(51) Int. Cl. G06F 9/48

(52) U.S. Cl. CPC G06F 9/4881

(57) ABSTRACT

Disclosed in the present application are a task scheduling method and apparatus, and a terminal device and a storage medium. When tasks to be executed are generated, said tasks are firstly stored in task scheduling queues; a terminal determines a queue scheduling sequence for the task scheduling queues according to the execution priority levels of the task types of said tasks; and an arrangement sequence of said tasks is determined according to the queue scheduling sequence. In this way, the terminal can preferentially process a task to be executed in the foreground, thereby effectively controlling a processing time delay of the task to be executed in the foreground.

### TECHNICAL FIELD

The present application relates to the field of communication technologies, and in particular to a task scheduling method and an apparatus, and a terminal device and a storage medium.

### BACKGROUND TECHNOLOGY

During an operation of a terminal, multiple IO (Input/Output) and other tasks may be generated. In order to enable the multiple tasks to be executed in order, the terminal's memory (such as EMMC 5.1, UFS, etc.) can have a command queue NCQ (Native Command Queue) to store the tasks to be executed by the terminal. NCQ allows multiple tasks to be executed to be queued at a device end at the same time.

### SUMMARY OF INVENTION

### Technical Problem

When the terminal's background applications are being downloaded or installed, there may be a large number of background tasks waiting to be executed queued on NCQ. The foreground tasks to be executed generated by user interaction are queued after the background tasks to be executed in NCQ. When the background tasks are highly loaded, the foreground tasks to be executed are delayed too much, causing the system to freeze.

### Problem Solutions

### Technical Solutions

Embodiments of the present application provide a task scheduling method and an apparatus, and a terminal device and a storage medium, which can effectively control a delay of tasks to be executed on a terminal, reduce a possibility of excessive delay of foreground tasks to be executed when background tasks are highly loaded, and improve a system fluency.

Embodiments of the present application provide a task scheduling method, comprising:
obtaining several task scheduling queues of a terminal, wherein one task scheduling queue corresponds to storing a task to be executed of a task type in the terminal, and different task scheduling queues store different task types of tasks to be executed;
determining a queue scheduling order of each task scheduling queue when scheduling tasks to be executed into a task execution queue according to an execution priority of each task type;
obtaining the task execution queue, wherein the task execution queue comprises the tasks to be executed extracted from the task scheduling queues;
if a current queue depth of the task execution queue is less than a maximum queue depth of the task execution queue, calculating a target number of tasks to be executed that can be added to the task execution queue;
selecting the tasks to be executed from the task scheduling queues and adding the tasks to be executed to the task execution queue according to the queue scheduling order and the target number;
taking out the tasks to be executed from the task execution queue for processing.

Accordingly, embodiments of the present application further provide a task scheduling device, comprising:
a task scheduling queue obtainer configured to obtain several task scheduling queues of a terminal, wherein one task scheduling queue corresponds to storing a task to be executed of a task type in the terminal, and different task scheduling queues store different task types of tasks to be executed;
a queue scheduling order determiner configured to determine a queue scheduling order of each task scheduling queue when scheduling tasks to be executed into a task execution queue according to an execution priority of each task type;
a task execution queue obtainer configured to obtain the task execution queue, wherein the task execution queue comprises the tasks to be executed extracted from the task scheduling queues;
a calculator configured to calculate a target number of tasks to be executed that can be added to the task execution queue if a current queue depth of the task execution queue is less than a maximum queue depth of the task execution queue;
a selector configured to select the tasks to be executed from the task scheduling queues and add the tasks to be executed to the task execution queue according to the queue scheduling order and the target number;
a processor configured to take out the tasks to be executed from the task execution queue for processing.

Optionally, the task scheduling queue obtainer is further configured to:
create each of the task scheduling queues;
when the terminal generates the task to be executed, determine the task type of the task to be executed;
according to the task type of the task to be executed, store a generated task to be executed in a corresponding task scheduling queue.

Optionally, the selector is further configured to:
select the tasks to be executed from at least one task scheduling queue according to the queue scheduling order and the target number, wherein a number of tasks to be executed selected from each task scheduling queue does not exceed a single maximum task extraction number corresponding to the task scheduling queue, and a number of all selected tasks to be executed does not exceed the target number;
extract selected tasks to be executed from the task scheduling queue and add the selected tasks to be executed to the task execution queue.

Optionally, the selector is further configured to:
select the task scheduling queue that ranks first in the queue scheduling order as the current task scheduling queue;
if the target number does not exceed a maximum single task extraction number of the current task scheduling queue, and a sum of the number of tasks to be executed extracted from the current task scheduling queue to the task execution queue and the target number does not exceed the maximum number of tasks to be executed that can be extracted from the current task scheduling queue to the task execution queue, select the target number of tasks to be executed from the current task scheduling queue as the selected tasks to be executed;
if the target number exceeds the maximum number of tasks extracted from the current task scheduling queue at a time, and a sum of the number of tasks in storage that have been extracted from the current task scheduling queue to the task execution queue and the target number exceeds the maximum number of tasks in storage corresponding to the current task scheduling queue, use a next task scheduling queue as the current task scheduling queue according to the queue scheduling order;
if the target number does not exceed the maximum number of tasks extracted from the current task scheduling queue at a time, and the sum of the number of tasks in storage and the target number of tasks to be executed extracted from the current task scheduling queue to the task execution queue does not exceed the maximum number of tasks in storage that can be extracted from the current task scheduling queue to the task execution queue, perform selecting the target number of tasks to be executed from the current task scheduling queue until the current task scheduling queue is the task scheduling queue at an end of the queue scheduling order.

Optionally, the selector is further configured to:
select the task scheduling queue that ranks first in the queue scheduling order as the current task scheduling queue;
if the target number exceeds the single maximum task extraction number of the current task scheduling queue, and the number of tasks in storage of the tasks to be executed that have been extracted from the current task scheduling queue to the task execution queue does not exceed the maximum number of tasks in storage that the current task scheduling queue can extract to the task execution queue, calculate a first difference between the number of tasks in storage and the maximum number of tasks in storage of the current task scheduling queue, determine a smaller number from the first difference and the single maximum task extraction number of the current task scheduling queue as the extraction number of tasks to be executed selected from the current task scheduling queue, and take the next task scheduling queue as the current task scheduling queue according to the queue scheduling order;
if the target number exceeds the maximum number of tasks extracted from the current task scheduling queue at a time, and the number of tasks to be executed that have been extracted from the current task scheduling queue to the task execution queue is greater than or equal to the maximum number of tasks that can be extracted from the current task scheduling queue to the task execution queue, according to the queue scheduling order, use the next task scheduling queue as the current task scheduling queue;
obtain a second difference between the target number and the extraction number, and update the target number to the second difference;
return to execute if the target number exceeds the maximum single task extraction number of the current task scheduling queue, wherein the number of tasks in storage that have been extracted from the current task scheduling queue to the task execution queue does not exceed the maximum number of tasks in storage that the current task scheduling queue can extract to the task execution queue, calculate the first difference between the number of tasks in storage and the maximum number of tasks in storage in the current task scheduling queue, determine the smaller number from the first difference and the maximum single task extraction number of the current task scheduling queue as the extraction number of tasks to be executed selected from the current task scheduling queue, take the next task scheduling queue as the current task scheduling queue according to the queue scheduling order, until the current task scheduling queue is the task scheduling queue at an end of the queue scheduling order.

Optionally, the task scheduling device is further configured to:
detect an actual processing delay of each of the tasks to be executed, wherein the actual processing delay being a difference between a time when the task to be executed is added to the task scheduling queue and a time when the task to be executed is completed;
obtain the expected processing delay corresponding to each task scheduling queue;
update a maximum number of tasks in storage corresponding to each task scheduling queue according to the actual processing delay and an expected processing delay corresponding to each task scheduling queue.

Optionally, the task scheduling device is further configured to:
set the maximum processing delay of each task scheduling queue according to the expected processing delay of each task scheduling queue;
determine a number of timeout tasks corresponding to each scheduling task queue in a latest monitoring cycle, wherein the timeout task is a task whose actual processing delay exceeds the maximum processing delay of the scheduling task queue;
determine a target task scheduling queue whose execution priority level is greater than a preset level;
if a ratio of the number of tasks in the target scheduling task queue in the latest monitoring cycle to a total number of all tasks to be executed from the target scheduling task queue and completed in the processing exceeds a preset maximum ratio, then increase the maximum number of tasks in storage corresponding to the target task scheduling queue, wherein an increased maximum number of tasks in storage does not exceed the single maximum number of tasks extracted corresponding to the target task scheduling queue.

Similarly, embodiments of the present application further provide a terminal device, comprising:
a memory configured to store a computer program;
a processor configured to perform any step of the task scheduling method.

In addition, embodiments of the present application further provide a computer-readable storage medium, on which a computer program is stored, and when the computer program is executed by a processor, performing any step of the task scheduling method.

### Beneficial Effects of Invention

### Beneficial Effects

Embodiments of the present application provide a task scheduling method and an apparatus, and a terminal device and a storage medium, which can set up several task scheduling queues to store tasks to be executed. When a terminal generates a task to be executed, it may first be stored in the task scheduling queue. The terminal determines the queue scheduling order of each task scheduling queue when scheduling the task to be executed into the task execution queue according to the execution priority of the task type of the task to be executed. Therefore, it is possible to avoid queuing up the tasks to be executed in the task execution queue in the order in which the tasks to be executed are generated. Instead, the order in which tasks to be executed of various task types are arranged in the task execution queue is determined based on the queue scheduling sequence. When there are pending tasks that can be added to the task execution queue, the foreground pending tasks generated by the interaction between the terminal and the user can be added to the task execution queue first. This allows the terminal to prioritize tasks to be executed in the foreground, thereby reducing the processing delay of tasks to be executed in the foreground. This reduces the possibility of excessive delays in foreground tasks to be executed when there is a high load on background tasks, and improves system fluency.

### BRIEF DESCRIPTION OF THE DRAWINGS

### Description of Drawings

In order to more clearly illustrate the technical solutions in the embodiments of the present application, the drawings required to be implemented in the description of the embodiments are briefly introduced below. Obviously, the drawings described below are only some embodiments of the present invention. For those skilled in the art, other drawings can be obtained based on these drawings without creative work.

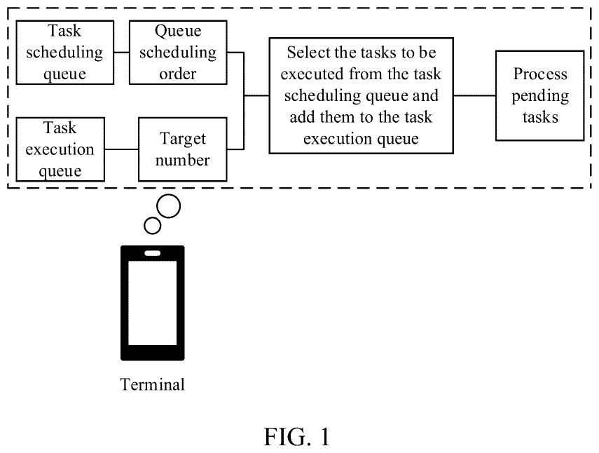

FIG. 1 is a system diagram of a task scheduling device provided in an embodiment of the present application.

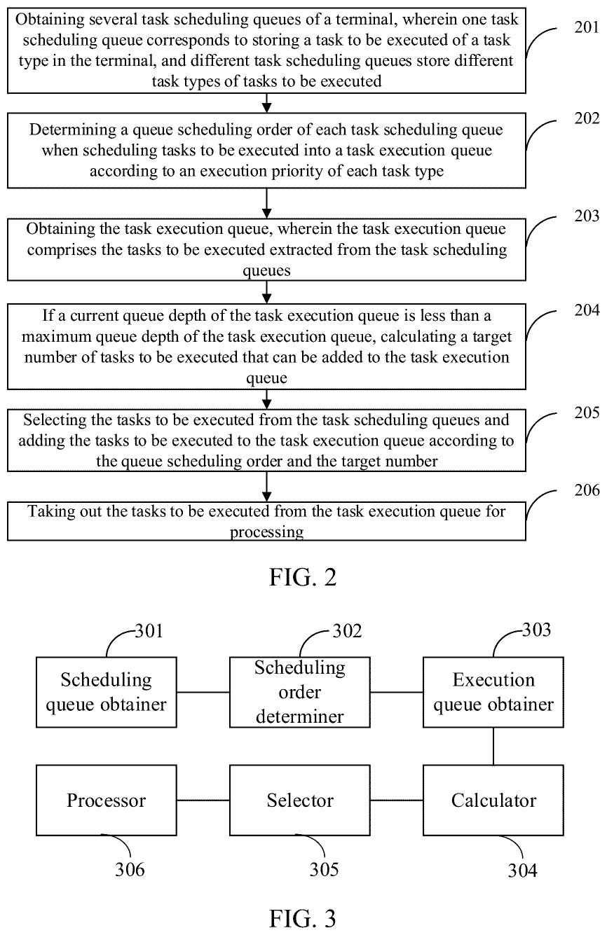

FIG. 2 is a flowchart of a task scheduling method provided in an embodiment of the present application.

FIG. 3 is a structural diagram of a task scheduling device provided in an embodiment of the present application.

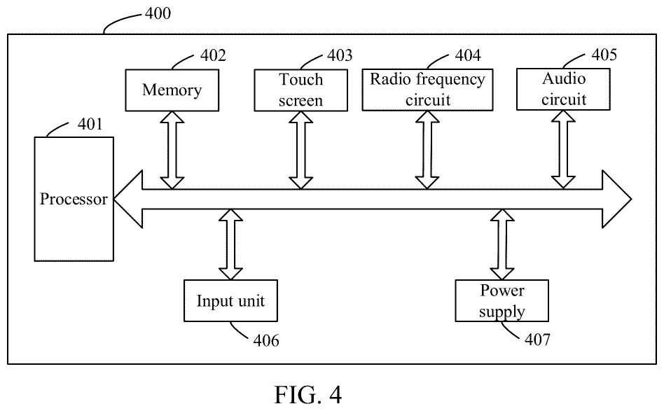

FIG. 4 is a structural diagram of a terminal device provided in an embodiment of the present application.

### DETAILED DESCRIPTION OF THE PREFERRED EMBODIMENTS

### Embodiments of Invention

The technical solutions in the embodiments of the present disclosure will be clearly and completely described below with reference to the accompanying drawings in the embodiments of the present disclosure. Obviously, the described embodiments are only some, but not all, embodiments of the present disclosure. Based on the embodiments in the present disclosure, all other embodiments obtained by those skilled in the art without creative efforts shall fall within the protection scope of the present disclosure.

Embodiments of the present application provide a task scheduling method and an apparatus, and a terminal device and a storage medium. Specifically, the task scheduling method of the embodiment of the present application can be executed by a terminal device. The terminal device can be a terminal or a server. The terminal can be a terminal device such as a smart phone, a tablet computer, a laptop computer, a touch screen, a game console, a personal computer (PC), a personal digital assistant (PDA) and the like. The terminal can also include a client, which can be a game application client, a browser client carrying a game program, or an instant messaging client. The server can be an independent physical server, or a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content distribution network services, and big data and artificial intelligence platforms.

Refer to FIG. 1, which is a system diagram of a task scheduling device provided in an embodiment of the present application. The system may include at least one terminal, and the terminal is used to obtain a plurality of task scheduling queues of the terminal, wherein one of the task scheduling queues corresponds to storing a task to be executed of a task type in the terminal, and different task scheduling queues store different types of tasks to be executed; according to the execution priority level of each task type, determine the queue scheduling order of each task scheduling queue when scheduling the tasks to be executed into the task execution queue; obtain the task execution queue, the task execution queue including the tasks to be executed extracted from the task scheduling queue; if the current queue depth of the task execution queue is less than the maximum queue depth of the task execution queue, calculate the target number of tasks to be executed that can be added to the task execution queue; according to the queue scheduling order and the target number, select the tasks to be executed from the task scheduling queue and add them to the task execution queue; take out the tasks to be executed from the task execution queue for processing.

It should be noted that the description order of the following embodiments is not intended to limit the preferred order of the embodiments.

This embodiment will be described from the perspective of a task scheduling device, which may be specifically integrated in a terminal device, which may include a smart phone, a laptop computer, a tablet computer, a personal computer, and other devices.

The embodiment of the present application provides a task scheduling method, which can be executed by a processor of a terminal. As shown in FIG. 2, the specific process of the task scheduling method mainly includes steps 201 to 206, which are described in detail as follows:

Step 201, obtaining several task scheduling queues of a terminal, wherein one task scheduling queue corresponds to storing a task to be executed of a task type in the terminal, and different task scheduling queues store different task types of tasks to be executed.

In the embodiments of the present application, a task refers to a basic work unit to be completed by a terminal, which is one or more instruction sequences processed by a program or a group of programs. For example, a read task, a write task, etc. of a terminal. A pending task refers to a task that has not been processed and completed by a terminal.

In the embodiment of the present application, the task type of the task to be executed can be divided according to factors such as the source of the task to be executed and the purpose of the task. For example, the source of the task to be executed of the terminal can be a foreground task generated by the interaction between the user and the terminal, or a background task generated and processed by a program in the terminal that the user cannot directly contact, etc. The task to be executed can be divided into a read task and a write task, etc. according to the different task purposes of reading or writing data.

In the embodiment of the present application, it is necessary to pre-create a task scheduling queue. Specifically, before “obtaining several task scheduling queues of the terminal” in the above step 201, it also includes:

Creating each of the task scheduling queues.

When the terminal generates the task to be executed, determining the task type of the task to be executed.

According to the task type of the task to be executed, the generated task to be executed is stored in a corresponding task scheduling queue.

In an embodiment of the present application, when creating a task scheduling queue, a task scheduling queue can be set to store tasks to be executed of a task type. For example, a task scheduling queue for storing foreground read tasks, a task scheduling queue for storing foreground write tasks, a task scheduling queue for storing background read tasks, and a task scheduling queue for storing background write tasks can be created. When a foreground read task is generated, the generated foreground read task is stored in the task scheduling queue for storing the foreground read task.

In the embodiment of the present application, in order to control the queue depth of each task scheduling queue, a maximum queue depth can be set for each task scheduling queue, so as to determine whether the generated task to be executed can be immediately added to the corresponding task scheduling queue. The above step of “according to the task type of the task to be executed, storing the generated task to be executed in the corresponding task scheduling queue” includes:

Determining, according to the task type of the task to be executed, a target task scheduling queue corresponding to the generated task to be executed.

Based on the number of tasks to be executed stored in the target task scheduling queue, determining that the current queue depth of the target task scheduling queue is less than the maximum queue depth of the target task scheduling queue.

Storing the generated tasks to be executed in the corresponding target task scheduling queue.

In one embodiment of the present application, the task scheduling queue adopts a FIFO (First Input First Output) scheduling method to process the stored tasks to be executed, that is, when extracting tasks to be executed from the task scheduling queue and adding them to the task execution queue, the tasks to be executed that enter the task scheduling queue first are extracted first and added to the task execution queue.

Step 202, determining a queue scheduling order of each task scheduling queue when scheduling tasks to be executed into a task execution queue according to an execution priority of each task type.

In the embodiment of the present application, since the foreground task is a task generated by interaction with the user, in order to avoid the user waiting too long for task processing, the execution priority of the foreground task can be set higher and the execution priority of the background task can be set lower.

In the embodiment of the present application, in order to allow tasks with higher execution priority to be taken out and executed in the task execution queue first, and the task execution queue is a first-in-first-out mechanism. It is necessary to add tasks with higher execution priority to the task execution queue for queuing. Therefore, when scheduling tasks to be executed to the task execution queue, it can be set to first extract tasks to be executed from the task scheduling queue storing tasks with higher execution priority and add them to the task execution queue. Then, extract tasks to be executed from the task scheduling queue storing tasks with lower execution priority and add them to the task execution queue. That is, the queue scheduling order is the order in which tasks to be executed are extracted from different task scheduling queues in sequence.

Step 203, obtaining the task execution queue, wherein the task execution queue comprises the tasks to be executed extracted from the task scheduling queues.

In the embodiment of the present application, the task execution queue is a command queue NCQ (Native Command Queue) in the terminal's memory (such as EMMC 5.1, UFS, etc.), which is used to store tasks to be executed generated by the terminal. NCQ allows multiple tasks to be executed to be queued at the device end at the same time, and the terminal processes them in sequence according to the arrangement order.

Step 204, if a current queue depth of the task execution queue is less than a maximum queue depth of the task execution queue, calculating a target number of tasks to be executed that can be added to the task execution queue.

In the embodiment of the present application, the queue depth is the number of pending tasks waiting to be processed in the task execution queue. The current queue depth is the number of pending tasks currently waiting to be processed in the task execution queue, and the maximum queue depth is the maximum number of pending tasks that can be stored in the task execution queue. In addition, the target number is the difference between the maximum queue depth and the current queue depth.

Step 205, selecting the tasks to be executed from the task scheduling queues and adding the tasks to be executed to the task execution queue according to the queue scheduling order and the target number.

In the embodiment of the present application, in the above step 205, “selecting tasks to be executed from the task scheduling queue and adding them to the task execution queue according to the queue scheduling order and the target number” can be:

According to the queue scheduling order and the target number, selecting tasks to be executed from at least one task scheduling queue, wherein the number of tasks to be executed selected from each task scheduling queue does not exceed the single maximum task extraction number corresponding to the task scheduling queue, and the number of all selected tasks to be executed does not exceed the target number.

The selected tasks to be executed are extracted from the task scheduling queue and added to the task execution queue.

In the embodiment of the present application, in order to control the execution priority of each task type of tasks to be executed and control the queue depth of the task execution queue, the maximum number of tasks to be executed extracted from each task scheduling queue can be set for each task scheduling queue. That is, each task scheduling queue corresponds to a single maximum number of tasks to be extracted.

In the embodiment of the present application, the tasks to be executed in the task execution queue required can be extracted from one task scheduling queue at a time. At this time, the above step “selecting tasks to be executed from at least one task scheduling queue according to the queue scheduling order and the target number” can be:
selecting the task scheduling queue that ranks first in the queue scheduling order as the current task scheduling queue;
if the target number does not exceed a maximum single task extraction number of the current task scheduling queue, and a sum of the number of tasks to be executed extracted from the current task scheduling queue to the task execution queue and the target number does not exceed the maximum number of tasks to be executed that can be extracted from the current task scheduling queue to the task execution queue, selecting the target number of tasks to be executed from the current task scheduling queue as the selected tasks to be executed;
if the target number exceeds the maximum number of tasks extracted from the current task scheduling queue at a time, and a sum of the number of tasks in storage that have been extracted from the current task scheduling queue to the task execution queue and the target number exceeds the maximum number of tasks in storage corresponding to the current task scheduling queue, using a next task scheduling queue as the current task scheduling queue according to the queue scheduling order;
if the target number does not exceed the maximum number of tasks extracted from the current task scheduling queue at a time, and the sum of the number of tasks in storage and the target number of tasks to be executed extracted from the current task scheduling queue to the task execution queue does not exceed the maximum number of tasks in storage that can be extracted from the current task scheduling queue to the task execution queue, performing selecting the target number of tasks to be executed from the current task scheduling queue until the current task scheduling queue is the task scheduling queue at an end of the queue scheduling order.

In the embodiment of the present application, when tasks to be executed can be added to the task execution queue, the tasks to be executed required by the task execution queue can be extracted from multiple task scheduling queues. At this time, the above step “selecting tasks to be executed from at least one task scheduling queue according to the queue scheduling order and the target number” can be:
selecting the task scheduling queue that ranks first in the queue scheduling order as the current task scheduling queue;
if the target number exceeds the single maximum task extraction number of the current task scheduling queue, and the number of tasks in storage of the tasks to be executed that have been extracted from the current task scheduling queue to the task execution queue does not exceed the maximum number of tasks in storage that the current task scheduling queue can extract to the task execution queue, calculating a first difference between the number of tasks in storage and the maximum number of tasks in storage of the current task scheduling queue, determining a smaller number from the first difference and the single maximum task extraction number of the current task scheduling queue as the extraction number of tasks to be executed selected from the current task scheduling queue, and taking the next task scheduling queue as the current task scheduling queue according to the queue scheduling order;
if the target number exceeds the maximum number of tasks extracted from the current task scheduling queue at a time, and the number of tasks to be executed that have been extracted from the current task scheduling queue to the task execution queue is greater than or equal to the maximum number of tasks that can be extracted from the current task scheduling queue to the task execution queue, according to the queue scheduling order, using the next task scheduling queue as the current task scheduling queue;
obtaining a second difference between the target number and the extraction number, and updating the target number to the second difference;
returning to execute if the target number exceeds the maximum single task extraction number of the current task scheduling queue, wherein the number of tasks in storage that have been extracted from the current task scheduling queue to the task execution queue does not exceed the maximum number of tasks in storage that the current task scheduling queue can extract to the task execution queue, calculating the first difference between the number of tasks in storage and the maximum number of tasks in storage in the current task scheduling queue, determining the smaller number from the first difference and the maximum single task extraction number of the current task scheduling queue as the extraction number of tasks to be executed selected from the current task scheduling queue, taking the next task scheduling queue as the current task scheduling queue according to the queue scheduling order, until the current task scheduling queue is the task scheduling queue at an end of the queue scheduling order.

In the embodiment of the present application, the processing delay of each task type to be executed is further controlled, and the maximum number of tasks in storage corresponding to each task scheduling queue can be adjusted in real time. Specifically, the method for adjusting the maximum number of tasks in storage can be:
detecting an actual processing delay of each of the tasks to be executed, wherein the actual processing delay being a difference between a time when the task to be executed is added to the task scheduling queue and a time when the task to be executed is completed;
obtaining the expected processing delay corresponding to each task scheduling queue;
updating a maximum number of tasks in storage corresponding to each task scheduling queue according to the actual processing delay and an expected processing delay corresponding to each task scheduling queue.

In the embodiment of the present application, the expected processing delay corresponding to each task scheduling queue is the processing delay of the to-be-executed tasks stored in each task scheduling queue.

In an embodiment of the present application, the above step of “updating the maximum number of tasks stored corresponding to each task scheduling queue according to the actual processing delay and the expected processing delay corresponding to each task scheduling queue” may be:

Setting the maximum processing delay of each task scheduling queue according to the expected processing delay of each task scheduling queue.

Determining a number of timeout tasks corresponding to each scheduling task queue in a latest monitoring cycle, wherein the timeout task is a task whose actual processing delay exceeds the maximum processing delay of the scheduling task queue.

Determining a target task scheduling queue whose execution priority level is greater than a preset level.

If a ratio of the number of tasks in the target scheduling task queue in the latest monitoring cycle to a total number of all tasks to be executed from the target scheduling task queue and completed in the processing exceeds a preset maximum ratio, then increasing the maximum number of tasks in storage corresponding to the target task scheduling queue, wherein an increased maximum number of tasks in storage does not exceed the single maximum number of tasks extracted corresponding to the target task scheduling queue.

The maximum processing delay of each task scheduling queue is the maximum processing delay of the tasks to be executed stored in each task scheduling queue. The maximum processing delay can be obtained by performing a certain calculation on the expected processing delay. For example, the maximum processing delay can be n times the expected processing delay.

The length of the monitoring cycle is not limited and can be flexibly set according to actual conditions. In addition, the value of the preset maximum ratio is not limited and can be flexibly set according to actual conditions. The preset maximum ratio corresponding to each task scheduling queue can be different, partially the same, or completely the same.

In embodiments of the present application, the tasks to be executed stored in the target task scheduling queue are tasks to be executed with a higher execution priority. If the ratio calculated by the target scheduling task queue exceeds the preset maximum ratio, it indicates that the processing delay of the tasks to be executed with a higher execution priority is large, and the system is prone to freeze. At this time, in order to speed up the processing speed of the tasks to be executed stored in the target scheduling task queue, the number of tasks to be executed extracted from the target scheduling task queue and added to the task execution queue can be increased.

In an implementation manner of the present application, the candidate task scheduling queue with the largest total number of tasks to be executed that has been processed within the monitoring period can be obtained. That is, the number of tasks to be executed stored in the candidate task scheduling queue and completed in the latest monitoring cycle is greater than the number of tasks to be executed stored in other task scheduling queues and completed in the latest monitoring cycle. If the execution priority level of the tasks to be executed stored in the candidate task scheduling queue is lower than the preset level, and the processing delay of the tasks to be executed stored in the target task scheduling queue with a higher execution priority level in the latest monitoring period is larger. This can reduce the maximum number of existing tasks corresponding to the candidate task scheduling queue, thereby reducing the processing delay of tasks to be executed stored in the target task scheduling queue. In addition, the reduced maximum number of existing tasks does not exceed the single maximum number of task extractions corresponding to the candidate task scheduling queue.

Step 206, taking out the tasks to be executed from the task execution queue for processing.

In embodiments of the present application, the task execution queue uses a FIFO (First Input First Output) scheduling method to process the stored tasks to be executed. That is, when the terminal extracts the tasks to be executed from the task execution queue for processing, the tasks to be executed that are first added to the task execution queue are extracted first for processing.

All of the above technical solutions can be arbitrarily combined to form optional embodiments of the present application, which will not be described one by one here.

The task scheduling method provided by embodiments of the present application can set up several task scheduling queues that store tasks to be executed. When the terminal generates a task to be executed, it may first be stored in the task scheduling queue. The terminal determines the queue scheduling order of each task scheduling queue when scheduling the task to be executed into the task execution queue according to the execution priority of the task type of the task to be executed. Therefore, it is possible to avoid queuing up the tasks to be executed in the task execution queue in the order in which the tasks to be executed are generated. Instead, the order in which tasks to be executed of various task types are arranged in the task execution queue is determined based on the queue scheduling sequence. When there are pending tasks that can be added to the task execution queue, the foreground pending tasks generated by the interaction between the terminal and the user can be added to the task execution queue first. This allows the terminal to prioritize tasks to be executed in the foreground, thereby reducing the processing delay of tasks to be executed in the foreground. This reduces the possibility of excessive delays in foreground tasks to be executed when there is a high load on background tasks, and improves system fluency.

For example, the task to be executed is an IO request of the terminal, and the task execution queue is at this time. The specific implementation process of the task scheduling method of the embodiment of the present application is as follows:

Step 1: create five IO scheduler queues in the IO scheduler to classify the IO requests generated by the terminal. The details are as follows:

FG READ queue: receive read IO requests from foreground applications, queue them in FIFO mode, insert the later IO requests into the tail of the queue, and the IO dispatcher selects IO requests from the head of the queue and adds them to NCQ.

FG WRITE queue: receive write IO requests from foreground applications, queue them in FIFO mode, insert the later IO requests to the end of the queue, and the IO dispatcher selects IO requests from the head of the queue and adds them to NCQ.

BG READ queue: receive read IO requests from background applications, queue them in FIFO mode, insert the later IO requests to the end of the queue, and the IO dispatcher selects IO requests from the head of the queue and adds them to NCQ.

Discard queue: Receive discard (cancel operation) requests from the file system layer, queue them in FIFO mode, and insert the later IO requests into the tail of the queue. The IO dispatcher selects IO requests from the head of the queue and adds them to the NCQ.

Others queue: receive other IO requests, such as background write IO requests, flush (data clearing) requests, etc. Queuing is done in FIFO mode, and the later IO requests are inserted into the tail of the queue. The IO dispatcher selects IO requests from the head of the queue and adds them to NCQ.

Step 2: set the latency and dispatch parameters for different IO scheduler queues as follows:
exp_latency: expected IO processing latency. Generally, FG READ has the highest processing latency requirement, therefore, FG READ can be set to the shortest processing latency. Other IO scheduler queues can be adjusted according to actual needs. For example, FG READ is set to 1 ms, FG WRITE is set to 10 ms, BG READ is set to 5 ms, DISCARD is set to 20 ms, and OTHERS is set to 100 ms.
max_queue: The maximum number of IOs allowed to enter this IO scheduling queue. Since the number of requests in the block device IO request queue is limited (usually 128), if a large number of background IOs exhaust all IO requests. Then the foreground IO may wait for the request to be available, causing high latency, therefore it is necessary to set a certain limit on the queue depth of each IO scheduler. For example, you can set FG READ to 128, FG WRITE to 64, BG READ to 64, DISCARD to 32, and OTHERS to 32.
max_dispatch: The maximum number of IO requests that this IO dispatch queue is allowed to dispatch to NCQ at one time, which is used to control the IO priority and NCQ queue depth. In general, FG READ is not restricted, and other IO queues are subject to certain restrictions. For example, for a device with an NCQ queue depth of 32, you can set FG READ to 32, FG WRITE to 24, BG READ to 24, DISCARD to 16, and OTHERS to 8.
io_window: The monitoring period for IO latency statistics, for example 100 ms.

Step 3: monitor the latency of the IOs stored in each IO scheduling queue and adjust the number of IOs that the queue is allowed to queue in the NCQ queue, denoted as max_inflight. The specific method is as follows.

Step 3.1: initialize the max_inflight of each IO scheduler queue to the max_dispatch value set by the user.

Step 3.2: IO latency of each IO scheduling queue is divided into 8 intervals according to the exp_latency set by the user for statistics. That is, [0,0.25) exp_latency, [0.25, 0.5) exp_latency, [0.5, 0.75) exp_latency, [0.75, 1) exp_latency, [1,1.25) exp_latency, [1.25,1.5) exp_latency, [1.5, 1.75) exp_latency, [1.75, 2) exp_latency, [2, infinity) exp_latency. Initialize the number of IOs in each interval to 0, and record the start time of the monitoring period window_start as the current system time.

Step 3.3: monitor the IO latency stored in each task scheduling queue in the latest cycle. The time when an IO request is inserted into the IO scheduler queue is recorded as to, and the time when the IO is completed is recorded as t1, then the latency of this IO is latency=t1-t0.

Step 3.4: when the IO is completed, update the latency statistics of the IO queue according to the latency interval in which the IO latency falls. That is, the corresponding interval IO number +1, and determine the interval between the current system time and the start time window_start of the monitoring cycle. If it exceeds the window size io_window, update the IO latency statistics based on the past window. max_inflight, and reinitialize the number of IO records and window_start in each interval. The update rules of max_inflight are as follows from steps 3.5 to 3.9:

Step 3.5: count the 99% maximum latency of IO on each IO scheduler queue. For example, the exp_latency of the IO scheduler queue is set to 2 ms, the monitoring cycle size is 1s, and 500 IOs are processed and completed in the latest monitoring cycle. The actual processing latency of 400 IOs is 0.1 ms, the actual processing latency of 50 IOs is 0.5 ms, the actual processing latency of 20 IOs is 1 ms, the actual processing latency of 10 IOs is 1.5 ms, the actual processing latency of 10 IOs is 2 ms, the actual processing latency of 5 IOs is 3 ms, and the actual processing latency of 5 IOs is 5 ms. Then the maximum processing latency of 99% of IOs (i.e. 495 IOs) is 3 ms, which falls in the interval [1.5,1.75) exp_latency, and the maximum latency of 99% IOs is 1.75 exp_latency.

Step 3.6: traverse the five IO scheduler queues and find the queue with the highest latency requirement (that is, the smallest exp_latency set by the user) and 99% maximum latency exceeding 2 times exp_latency. Record it as Q1. For example, find the FG READ queue here.

Step 3.7: Traverse the five IO scheduler queues and find the IO scheduler queue with a latency requirement lower than Q1 (based on the size of exp_latency. That is, the exp_latency size is greater than the exp_latency of Q1) and the IO scheduler queue that processes the most IOs in the latest monitoring cycle, recorded as Q2. For example, the OTHERS queue is found here.

Step 3.8: If both Q1 and Q2 exist, halve the max_inflight of Q2 and make sure that the halved max_inflight does not exceed the max_dispatch corresponding to Q2. That is, it is limited to the range [1, max_dispatch]. By reducing the throughput of Q2, the IO latency of Q1 is reduced. In addition, if the halved max_inflight of Q2 does not belong to [1, max_dispatch], Q2's max_inflight=max (1, min (max_inflight/2, max_dispatch)) can be processed.

Step 3.9: If only Q1 exists, double Q1's max_inflight and make sure that the doubled max_inflight does not exceed Q1's corresponding max_dispatch, and is limited to the range of [1, max_dispatch] to improve Q1's IO throughput. In addition, if Q1's max_inflight does not fall within [1, max_dispatch] after doubling, Q1's max_inflight=max (1, min (max_inflight*2, max_dispatch)) can also be set.

Step 4: The IO dispatcher is responsible for selecting IO requests from the five IO scheduler queues and sending them to the NCQ queue. The specific rules are as follows:

Step 4.1: Initialize the number of IO dispatches in this round of each IO scheduler queue to 0.

Step 4.2: If you obtain an available slot in the NCQ queue, if the current NCQ queue is full, you will have to wait for an IO to complete before obtaining an available slot.

Step 4.3: If the FG READ queue is not empty, and the number of IO requests dispatched from this queue in this round, nr_dispatch, does not exceed max_dispatch, and the sum of the number of FG READ requests queued in NCQ, nr_inflight, and the available slots in the NCQ queue does not exceed max_inflight, then select a READ request from the head of the FG READ queue and send it to the NCQ queue, and at the same time, nr_inflight and nr_dispatch are increased by 1; then return to step 4.2.

Step 4.4: If no IO is selected for dispatch in step 4.3 (the queue is empty or the number of dispatched IO exceeds the limit), consider selecting IO from the FG WRITE queue for dispatch. Similarly, if the FG WRITE queue is not empty, and the number of IO requests dispatched from this queue in this round, nr_dispatch, does not exceed max_dispatch. If the sum of the number of FG WRITE requests queued in NCQ, nr_inflight, and the available slots in the NCQ queue does not exceed max_inflight, then select a WRITE request from the head of the FG WRITE queue and dispatch it to the NCQ queue, and at the same time, nr_inflight is increased by 1, and nr_dispatch is increased by 1; then repeat step 4.2.

Step 4.5: If no IO is selected for dispatch in step 4.4 (the queue is empty or the number of dispatched IO exceeds the limit), consider selecting IO from the BG READ queue for dispatch. Similarly, if the BG READ queue is not empty, and the number of IO requests dispatched from this queue in this round, nr_dispatch, does not exceed max_dispatch, and the sum of the number of BG READ requests queued in NCQ, nr_inflight, and the available slots in the NCQ queue does not exceed max_inflight, then select a READ request from the head of the BG READ queue and dispatch it to the NCQ queue, and at the same time, nr_inflight is increased by 1, and nr_dispatch is increased by 1; then return to step 4.2.

Step 4.6: If no IO is selected for dispatch in step 4.5 (the queue is empty or the number of dispatched IO exceeds the limit), consider selecting IO from the DISCARD queue for dispatch. Similarly, if the DISCARD queue is not empty, and the number of IO requests dispatched from this queue in this round, nr_dispatch, does not exceed max_dispatch, and the sum of the number of BG READ requests queued in NCQ, nr_inflight, and the available slots in the NCQ queue does not exceed max_inflight, then select a DISCARD request from the head of the DISCARD queue and dispatch it to the NCQ queue, and at the same time, nr_inflight and nr_dispatch are increased by 1; then return to step 4.2.

Step 4.7: If no IO is selected for dispatch in step 4.6 (the queue is empty or the number of dispatched IO exceeds the limit), consider selecting IO from the OTHERS queue for dispatch. Similarly, if the OTHERS queue is not empty, and the number of IO requests dispatched from this queue in this round, nr_dispatch, does not exceed max_dispatch, and the sum of the number of other IO requests queued in NCQ, nr_inflight, and the available slots in the NCQ queue does not exceed max_inflight, then select an IO request from the head of the OTHERS queue and dispatch it to the NCQ queue, and at the same time, nr_inflight is increased by 1, and nr_dispatch is increased by 1; then return to step 4.2.

Step 4.8: Return to step 4.1 and start a new round of IO distribution.

Step 4.9: When the IO is completed, update the nr_inflight of the corresponding IO scheduler queue according to the type of this IO (such as FG READ), that is, nr_inflight minus 1.

In order to facilitate better implementation of the task scheduling method of the embodiment of the present application, the embodiment of the present application also provides a task scheduling device. Please refer to FIG. 3, which is a structural diagram of the task scheduling device provided by the embodiment of the present application. The task scheduling device may include a scheduling queue obtainer 301, a scheduling order determiner 302, an execution queue obtainer 303, a calculator 304, a selector 305, and a processor 306.

The task scheduling queue obtainer 301 is configured to obtain several task scheduling queues of a terminal, wherein one task scheduling queue corresponds to storing a task to be executed of a task type in the terminal, and different task scheduling queues store different task types of tasks to be executed.

The queue scheduling order determiner 302 is configured to determine a queue scheduling order of each task scheduling queue when scheduling tasks to be executed into a task execution queue according to an execution priority of each task type.

The task execution queue obtainer 303 is configured to obtain the task execution queue, wherein the task execution queue comprises the tasks to be executed extracted from the task scheduling queues.

The calculator 304 is configured to calculate a target number of tasks to be executed that can be added to the task execution queue if a current queue depth of the task execution queue is less than a maximum queue depth of the task execution queue.

The selector 305 is configured to select the tasks to be executed from the task scheduling queues and add the tasks to be executed to the task execution queue according to the queue scheduling order and the target number.

The processor 306 is configured to take out the tasks to be executed from the task execution queue for processing.

Optionally, the task scheduling queue obtainer 301 is further configured to:
create each of the task scheduling queues;
when the terminal generates the task to be executed, determine the task type of the task to be executed;
according to the task type of the task to be executed, store a generated task to be executed in a corresponding task scheduling queue.

Optionally, the selector 305 is further configured to:
select the tasks to be executed from at least one task scheduling queue according to the queue scheduling order and the target number, wherein a number of tasks to be executed selected from each task scheduling queue does not exceed a single maximum task extraction number corresponding to the task scheduling queue, and a number of all selected tasks to be executed does not exceed the target number;
extract selected tasks to be executed from the task scheduling queue and add the selected tasks to be executed to the task execution queue.

Optionally, the selector 305 is further configured to:
select the task scheduling queue that ranks first in the queue scheduling order as the current task scheduling queue;
if the target number does not exceed a maximum single task extraction number of the current task scheduling queue, and a sum of the number of tasks to be executed extracted from the current task scheduling queue to the task execution queue and the target number does not exceed the maximum number of tasks to be executed that can be extracted from the current task scheduling queue to the task execution queue, select the target number of tasks to be executed from the current task scheduling queue as the selected tasks to be executed;
if the target number exceeds the maximum number of tasks extracted from the current task scheduling queue at a time, and a sum of the number of tasks in storage that have been extracted from the current task scheduling queue to the task execution queue and the target number exceeds the maximum number of tasks in storage corresponding to the current task scheduling queue, use a next task scheduling queue as the current task scheduling queue according to the queue scheduling order;
if the target number does not exceed the maximum number of tasks extracted from the current task scheduling queue at a time, and the sum of the number of tasks in storage and the target number of tasks to be executed extracted from the current task scheduling queue to the task execution queue does not exceed the maximum number of tasks in storage that can be extracted from the current task scheduling queue to the task execution queue, perform selecting the target number of tasks to be executed from the current task scheduling queue until the current task scheduling queue is the task scheduling queue at an end of the queue scheduling order.

Optionally, the selector 305 is further configured to:
select the task scheduling queue that ranks first in the queue scheduling order as the current task scheduling queue;
if the target number exceeds the single maximum task extraction number of the current task scheduling queue, and the number of tasks in storage of the tasks to be executed that have been extracted from the current task scheduling queue to the task execution queue does not exceed the maximum number of tasks in storage that the current task scheduling queue can extract to the task execution queue, calculate a first difference between the number of tasks in storage and the maximum number of tasks in storage of the current task scheduling queue, determine a smaller number from the first difference and the single maximum task extraction number of the current task scheduling queue as the extraction number of tasks to be executed selected from the current task scheduling queue, and take the next task scheduling queue as the current task scheduling queue according to the queue scheduling order;
if the target number exceeds the maximum number of tasks extracted from the current task scheduling queue at a time, and the number of tasks to be executed that have been extracted from the current task scheduling queue to the task execution queue is greater than or equal to the maximum number of tasks that can be extracted from the current task scheduling queue to the task execution queue, according to the queue scheduling order, use the next task scheduling queue as the current task scheduling queue;
obtain a second difference between the target number and the extraction number, and update the target number to the second difference;
return to execute if the target number exceeds the maximum single task extraction number of the current task scheduling queue, wherein the number of tasks in storage that have been extracted from the current task scheduling queue to the task execution queue does not exceed the maximum number of tasks in storage that the current task scheduling queue can extract to the task execution queue, calculate the first difference between the number of tasks in storage and the maximum number of tasks in storage in the current task scheduling queue, determine the smaller number from the first difference and the maximum single task extraction number of the current task scheduling queue as the extraction number of tasks to be executed selected from the current task scheduling queue, take the next task scheduling queue as the current task scheduling queue according to the queue scheduling order, until the current task scheduling queue is the task scheduling queue at an end of the queue scheduling order.

Optionally, the task scheduling device is further configured to:
detect an actual processing delay of each of the tasks to be executed, wherein the actual processing delay being a difference between a time when the task to be executed is added to the task scheduling queue and a time when the task to be executed is completed;
obtain the expected processing delay corresponding to each task scheduling queue;
update a maximum number of tasks in storage corresponding to each task scheduling queue according to the actual processing delay and an expected processing delay corresponding to each task scheduling queue.

Optionally, the task scheduling device is further configured to:
set the maximum processing delay of each task scheduling queue according to the expected processing delay of each task scheduling queue;
determine a number of timeout tasks corresponding to each scheduling task queue in a latest monitoring cycle, wherein the timeout task is a task whose actual processing delay exceeds the maximum processing delay of the scheduling task queue;
determine a target task scheduling queue whose execution priority level is greater than a preset level;
if a ratio of the number of tasks in the target scheduling task queue in the latest monitoring cycle to a total number of all tasks to be executed from the target scheduling task queue and completed in the processing exceeds a preset maximum ratio, then increase the maximum number of tasks in storage corresponding to the target task scheduling queue, wherein an increased maximum number of tasks in storage does not exceed the single maximum number of tasks extracted corresponding to the target task scheduling queue.

All of the above technical solutions can be arbitrarily combined to form optional embodiments of the present application, which will not be described one by one here.

The task scheduling device provided in the embodiment of the present application can be set to store several task scheduling queues for tasks to be executed. When a terminal generates a task to be executed, it may first be stored in the task scheduling queue. The terminal determines the queue scheduling order of each task scheduling queue when scheduling the task to be executed into the task execution queue according to the execution priority of the task type of the task to be executed. Therefore, it is possible to avoid queuing up the tasks to be executed in the task execution queue in the order in which the tasks to be executed are generated. Instead, the order in which tasks to be executed of various task types are arranged in the task execution queue is determined based on the queue scheduling sequence. When there are pending tasks that can be added to the task execution queue, the foreground pending tasks generated by the interaction between the terminal and the user can be added to the task execution queue first. This allows the terminal to prioritize tasks to be executed in the foreground, thereby reducing the processing delay of tasks to be executed in the foreground. This reduces the possibility of excessive delays in foreground tasks to be executed when there is a high load on background tasks, and improves system fluency.

Accordingly, an embodiment of the present application also provides a terminal device. The terminal device may be a terminal. The terminal may be a terminal device such as a smart phone, a tablet computer, a laptop computer, a touch screen, a game console, a personal computer, a personal digital assistant, etc. As shown in FIG. 4, FIG. 4 is a schematic diagram of the structure of the terminal device provided in the embodiment of the present application. The terminal device 400 includes a processor 401 having one or more processing cores, a memory 402 having one or more computer-readable storage media, and a computer program stored in the memory 402 and executable on the processor. The processor 401 is electrically connected to the memory 402. Those skilled in the art may understand that the terminal device structure shown in the figure does not constitute a limitation on the terminal device, and may include more or fewer components than shown in the figure, or combine certain components, or arrange components differently.

The processor 401 is a control center of the terminal device 400. It uses various interfaces and lines to connect the various parts of the entire terminal device 400, executes various functions of the terminal device 400 and processes data by running or loading software programs and/or modules stored in the memory 402, and calling data stored in the memory 402, thereby monitoring the terminal device 400 as a whole.

In the embodiment of the present application, the processor 401 in the terminal device 400 will load instructions corresponding to the processes of one or more application programs into the memory 402 according to the following steps, and the processor 401 will run the application programs stored in the memory 402 to implement various functions:
obtaining several task scheduling queues of a terminal, wherein one task scheduling queue corresponds to storing a task to be executed of a task type in the terminal, and different task scheduling queues store different task types of tasks to be executed;
determining a queue scheduling order of each task scheduling queue when scheduling tasks to be executed into a task execution queue according to an execution priority of each task type;
obtaining the task execution queue, wherein the task execution queue comprises the tasks to be executed extracted from the task scheduling queues;
if a current queue depth of the task execution queue is less than a maximum queue depth of the task execution queue, calculating a target number of tasks to be executed that can be added to the task execution queue;
selecting the tasks to be executed from the task scheduling queues and adding the tasks to be executed to the task execution queue according to the queue scheduling order and the target number;
taking out the tasks to be executed from the task execution queue for processing.

The specific implementation of the above operations can be found in the previous embodiments, which will not be described in detail here.

Optionally, as shown in FIG. 4, the terminal device 400 further includes: a touch screen 403, a radio frequency circuit 404, an audio circuit 405, an input unit 406, and a power supply 407. The processor 401 is electrically connected to the touch screen 403, the radio frequency circuit 404, the audio circuit 405, the input unit 406, and the power supply 407, respectively. Those skilled in the art can understand that the terminal device structure shown in FIG. 4 does not constitute a limitation on the terminal device, and may include more or fewer components than shown in the figure, or combine certain components, or arrange components differently.

The touch display screen 403 can be used to display a graphical user interface and receive operation instructions generated by the user acting on the graphical user interface. The touch display screen 403 can include a display panel and a touch panel. The display panel can be used to display information input by the user or information provided to the user and various graphical user interfaces of the terminal device, which can be composed of graphics, text, icons, videos and any combination thereof. Optionally, the display panel can be configured in the form of a liquid crystal display (LCD), an organic light-emitting diode (OLED), etc. The touch panel can be used to collect the user's touch operations on or near it (such as the user's operation of any suitable object or accessory such as a finger, a stylus, etc. on the touch panel or near the touch panel), and generate corresponding operation instructions, and the operation instructions execute the corresponding program. Optionally, the touch panel may include two parts: a touch detection device and a touch controller. The touch detection device detects the user's touch direction, detects the signal brought by the touch operation, and transmits the signal to the touch controller. The touch controller receives touch information from the touch detection device, converts it into touch point coordinates, and then sends it to the processor 401, and can receive and execute commands sent by the processor 401. The touch panel can cover the display panel. When the touch panel detects a touch operation on or near it, it is transmitted to the processor 401 to determine the type of touch event. The processor 401 then provides corresponding visual output on the display panel according to the type of touch event. In the embodiment of the present application, the touch panel and the display panel can be integrated into the touch display screen 403 to realize the input and output functions. However, in some embodiments, the touch panel and the touch panel can be used as two independent components to realize the input and output functions. That is, the touch display screen 403 can also be used as a part of the input unit 406 to realize the input function.

The radio frequency circuit 404 may be used to send and receive radio frequency signals, so as to establish wireless communication with a network device or other terminal devices through wireless communication, and to send and receive signals with the network device or other terminal devices.

The audio circuit 405 can be used to provide an audio interface between the user and the terminal device through a speaker and a microphone. The audio circuit 405 can transmit the electrical signal converted from the received audio data to the speaker, and the speaker converts it into a sound signal for output. On the other hand, the microphone converts the collected sound signal into an electrical signal. After being received by the audio circuit 405, it is converted into audio data, and then the audio data is processed by the output processor 401, and then sent to another terminal device through the radio frequency circuit 404, or the audio data is output to the memory 402 for further processing. The audio circuit 405 may also include an earplug jack to provide communication between an external headset and the terminal device.

The input unit 406 may be used to receive input numbers, character information or user feature information (such as fingerprint, iris, facial information, etc.), and generate keyboard, mouse, joystick, optical or trackball signal input related to user settings and function control.

The power supply 407 is used to supply power to various components of the terminal device 400. Optionally, the power supply 407 can be logically connected to the processor 401 through a power management system, so as to manage charging, discharging, and power consumption through the power management system. The power supply 407 can also include one or more DC or AC power supplies, recharging systems, power fault detection circuits, power converters or inverters, power status indicators, and other arbitrary components.

Although not shown in FIG. 4, the terminal device 400 may also include a camera, a sensor, a wireless fidelity module, a Bluetooth module, etc., which will not be described in detail here.

In the above embodiments, the description of each embodiment has its own emphasis. For parts that are not described in detail in a certain embodiment, reference can be made to the relevant descriptions of other embodiments.

As can be seen from the above, the terminal device provided in this embodiment can be set up with several task scheduling queues for storing tasks to be executed. When a terminal generates a task to be executed, it may first be stored in the task scheduling queue. The terminal determines the queue scheduling order of each task scheduling queue when scheduling the task to be executed into the task execution queue according to the execution priority of the task type of the task to be executed. Therefore, it is possible to avoid queuing up the tasks to be executed in the task execution queue in the order in which the tasks to be executed are generated. Instead, the order in which tasks to be executed of various task types are arranged in the task execution queue is determined based on the queue scheduling sequence. When there are pending tasks that can be added to the task execution queue, the foreground pending tasks generated by the interaction between the terminal and the user can be added to the task execution queue first. This allows the terminal to prioritize tasks to be executed in the foreground, thereby reducing the processing delay of tasks to be executed in the foreground. This reduces the possibility of excessive delays in foreground tasks to be executed when there is a high load on background tasks, and improves system fluency.

Those skilled in the art will appreciate that all or part of the steps in the various methods of the above embodiments may be completed by instructions, or by controlling related hardware through instructions. The instructions may be stored in a computer-readable storage medium and loaded and executed by a processor.

To this end, an embodiment of the present application provides a computer-readable storage medium, in which multiple computer programs are stored, and the computer program can be loaded by a processor to execute the steps in any task scheduling method provided in the embodiment of the present application. For example, the computer program can execute the following steps:
obtaining several task scheduling queues of a terminal, wherein one task scheduling queue corresponds to storing a task to be executed of a task type in the terminal, and different task scheduling queues store different task types of tasks to be executed;
determining a queue scheduling order of each task scheduling queue when scheduling tasks to be executed into a task execution queue according to an execution priority of each task type;
obtaining the task execution queue, wherein the task execution queue comprises the tasks to be executed extracted from the task scheduling queues;
if a current queue depth of the task execution queue is less than a maximum queue depth of the task execution queue, calculating a target number of tasks to be executed that can be added to the task execution queue;
selecting the tasks to be executed from the task scheduling queues and adding the tasks to be executed to the task execution queue according to the queue scheduling order and the target number;
taking out the tasks to be executed from the task execution queue for processing.

The specific implementation of the above operations can be found in the previous embodiments, which will not be described in detail here.

The storage medium may include: a read-only memory (ROM), a random access memory (RAM), a magnetic disk or an optical disk, etc.

Since the computer program stored in the storage medium can execute the steps in any task scheduling method provided in the embodiment of the present application, the beneficial effects that can be achieved by any task scheduling method provided in the embodiment of the present application can be achieved, as detailed in the previous embodiment, which will not be repeated here.

In the above embodiments, the description of each embodiment has its own emphasis. For parts that are not described in detail in a certain embodiment, reference can be made to the relevant descriptions of other embodiments.

The above is a detailed introduction to a task scheduling method, device, terminal device and storage medium provided in the embodiments of the present application. This article uses specific examples to illustrate the principles and implementation methods of the present invention. The description of the above embodiments is only used to help understand the technical solutions and core ideas of the present invention. Ordinary technicians in this field should understand that they can still modify the technical solutions recorded in the above embodiments, or replace some of the technical features therein with equivalents. However, these modifications or replacements do not make the essence of the corresponding technical solutions deviate from the scope of the technical solutions of the embodiments of the present invention.

1. A task scheduling method, comprising:
obtaining several task scheduling queues of a terminal, wherein one task scheduling queue corresponds to storing a task to be executed of a task type in the terminal, and different task scheduling queues store different task types of tasks to be executed;
determining a queue scheduling order of each task scheduling queue when scheduling tasks to be executed into a task execution queue according to an execution priority of each task type;
obtaining the task execution queue, wherein the task execution queue comprises the tasks to be executed extracted from the task scheduling queues;
if a current queue depth of the task execution queue is less than a maximum queue depth of the task execution queue, calculating a target number of tasks to be executed that can be added to the task execution queue;
selecting the tasks to be executed from the task scheduling queues and adding the tasks to be executed to the task execution queue according to the queue scheduling order and the target number;
taking out the tasks to be executed from the task execution queue for processing.

2. The task scheduling method according to claim 1, wherein before obtaining the several task scheduling queues of the terminal, the method further comprises:
creating each of the task scheduling queues;
when the terminal generates the task to be executed, determining the task type of the task to be executed;
according to the task type of the task to be executed, storing a generated task to be executed in a corresponding task scheduling queue.

3. The task scheduling method according to claim 1, wherein selecting the tasks to be executed from the task scheduling queues and adding the tasks to be executed to the task execution queue according to the queue scheduling order and the target number comprises:
selecting the tasks to be executed from at least one task scheduling queue according to the queue scheduling order and the target number, wherein a number of tasks to be executed selected from each task scheduling queue does not exceed a single maximum task extraction number corresponding to the task scheduling queue, and a number of all selected tasks to be executed does not exceed the target number;
extracting selected tasks to be executed from the task scheduling queue and adding the selected tasks to be executed to the task execution queue.

4. The task scheduling method according to claim 3, wherein selecting the tasks to be executed from at least one task scheduling queue according to the queue scheduling order and the target number comprises:
selecting the task scheduling queue that ranks first in the queue scheduling order as the current task scheduling queue;
if the target number does not exceed a maximum single task extraction number of the current task scheduling queue, and a sum of the number of tasks to be executed extracted from the current task scheduling queue to the task execution queue and the target number does not exceed the maximum number of tasks to be executed that can be extracted from the current task scheduling queue to the task execution queue, selecting the target number of tasks to be executed from the current task scheduling queue as the selected tasks to be executed;
if the target number exceeds the maximum number of tasks extracted from the current task scheduling queue at a time, and a sum of the number of tasks in storage that have been extracted from the current task scheduling queue to the task execution queue and the target number exceeds the maximum number of tasks in storage corresponding to the current task scheduling queue, using a next task scheduling queue as the current task scheduling queue according to the queue scheduling order;
if the target number does not exceed the maximum number of tasks extracted from the current task scheduling queue at a time, and the sum of the number of tasks in storage and the target number of tasks to be executed extracted from the current task scheduling queue to the task execution queue does not exceed the maximum number of tasks in storage that can be extracted from the current task scheduling queue to the task execution queue, performing selecting the target number of tasks to be executed from the current task scheduling queue until the current task scheduling queue is the task scheduling queue at an end of the queue scheduling order.

5. The task scheduling method according to claim 3, wherein selecting the tasks to be executed from at least one task scheduling queue according to the queue scheduling order and the target number comprises:
selecting the task scheduling queue that ranks first in the queue scheduling order as the current task scheduling queue;
if the target number exceeds the single maximum task extraction number of the current task scheduling queue, and the number of tasks in storage of the tasks to be executed that have been extracted from the current task scheduling queue to the task execution queue does not exceed the maximum number of tasks in storage that the current task scheduling queue can extract to the task execution queue, calculating a first difference between the number of tasks in storage and the maximum number of tasks in storage of the current task scheduling queue, determining a smaller number from the first difference and the single maximum task extraction number of the current task scheduling queue as the extraction number of tasks to be executed selected from the current task scheduling queue, and taking the next task scheduling queue as the current task scheduling queue according to the queue scheduling order;
if the target number exceeds the maximum number of tasks extracted from the current task scheduling queue at a time, and the number of tasks to be executed that have been extracted from the current task scheduling queue to the task execution queue is greater than or equal to the maximum number of tasks that can be extracted from the current task scheduling queue to the task execution queue, according to the queue scheduling order, using the next task scheduling queue as the current task scheduling queue;
obtaining a second difference between the target number and the extraction number, and updating the target number to the second difference;
returning to execute if the target number exceeds the maximum single task extraction number of the current task scheduling queue, wherein the number of tasks in storage that have been extracted from the current task scheduling queue to the task execution queue does not exceed the maximum number of tasks in storage that the current task scheduling queue can extract to the task execution queue, calculating the first difference between the number of tasks in storage and the maximum number of tasks in storage in the current task scheduling queue, determining the smaller number from the first difference and the maximum single task extraction number of the current task scheduling queue as the extraction number of tasks to be executed selected from the current task scheduling queue, taking the next task scheduling queue as the current task scheduling queue according to the queue scheduling order, until the current task scheduling queue is the task scheduling queue at an end of the queue scheduling order.

6. The task scheduling method according to claim 3, further comprising:
detecting an actual processing delay of each of the tasks to be executed, wherein the actual processing delay being a difference between a time when the task to be executed is added to the task scheduling queue and a time when the task to be executed is completed;
obtaining the expected processing delay corresponding to each task scheduling queue;
updating a maximum number of tasks in storage corresponding to each task scheduling queue according to the actual processing delay and an expected processing delay corresponding to each task scheduling queue.

7. The task scheduling method according to claim 6, wherein updating the maximum number of tasks in storage corresponding to each task scheduling queue according to the actual processing delay and the expected processing delay corresponding to each task scheduling queue comprises:
setting the maximum processing delay of each task scheduling queue according to the expected processing delay of each task scheduling queue;
determining a number of timeout tasks corresponding to each scheduling task queue in a latest monitoring cycle, wherein the timeout task is a task whose actual processing delay exceeds the maximum processing delay of the scheduling task queue;
determining a target task scheduling queue whose execution priority level is greater than a preset level;
if a ratio of the number of tasks in the target scheduling task queue in the latest monitoring cycle to a total number of all tasks to be executed from the target scheduling task queue and completed in the processing exceeds a preset maximum ratio, then increasing the maximum number of tasks in storage corresponding to the target task scheduling queue, wherein an increased maximum number of tasks in storage does not exceed the single maximum number of tasks extracted corresponding to the target task scheduling queue.

8. The task scheduling method according to claim 2, wherein according to the task type of the task to be executed, storing the generated task to be executed in the corresponding task scheduling queue comprises:
determining the target task scheduling queue corresponding to the generated task to be executed according to the task type of the task to be executed;
determining that the current queue depth of the target task scheduling queue is less than the maximum queue depth of the target task scheduling queue based on a storage quantity of the tasks to be executed stored in the target task scheduling queue;
storing the generated task to be executed in the corresponding target task scheduling queue.

9. The task scheduling method according to claim 7, further comprising:
obtaining a candidate task scheduling queue with largest total number of pending tasks processed and completed within a monitoring cycle; if an execution priority of pending tasks stored in the candidate task scheduling queue is lower than the preset level, reducing the maximum number of tasks in storage corresponding to the candidate task scheduling queue, wherein a reduced maximum number of tasks in storage does not exceed the single maximum number of tasks extracted corresponding to the candidate task scheduling queue.

10. The task scheduling method according to claim 1, wherein the method further comprises: an execution priority of a foreground task is higher than an execution priority of a background task.

11. The task scheduling method according to claim 1, wherein the method further comprises: when scheduling the tasks to be executed into the task execution queue, setting first to extract the tasks to be executed from the task scheduling queue storing the tasks to be executed with a higher execution priority and add the tasks to be executed to the task execution queue, and then extracting the tasks to be executed from the task scheduling queue storing the tasks to be executed with a lower execution priority and add the tasks to be executed to the task execution queue.

12. A task scheduling device, comprising:
a task scheduling queue obtainer configured to obtain several task scheduling queues of a terminal, wherein one task scheduling queue corresponds to storing a task to be executed of a task type in the terminal, and different task scheduling queues store different task types of tasks to be executed;
a queue scheduling order determiner configured to determine a queue scheduling order of each task scheduling queue when scheduling tasks to be executed into a task execution queue according to an execution priority of each task type;
a task execution queue obtainer configured to obtain the task execution queue, wherein the task execution queue comprises the tasks to be executed extracted from the task scheduling queues;
a calculator configured to calculate a target number of tasks to be executed that can be added to the task execution queue if a current queue depth of the task execution queue is less than a maximum queue depth of the task execution queue;
a selector configured to select the tasks to be executed from the task scheduling queues and add the tasks to be executed to the task execution queue according to the queue scheduling order and the target number;
a processor configured to take out the tasks to be executed from the task execution queue for processing.

13. The task scheduling device according to claim 12, wherein the task scheduling queue obtainer is further configured to:
create each of the task scheduling queues;
when the terminal generates the task to be executed, determine the task type of the task to be executed;
according to the task type of the task to be executed, store a generated task to be executed in a corresponding task scheduling queue.

14. The task scheduling device according to claim 12, wherein the selector is further configured to:
select the tasks to be executed from at least one task scheduling queue according to the queue scheduling order and the target number, wherein a number of tasks to be executed selected from each task scheduling queue does not exceed a single maximum task extraction number corresponding to the task scheduling queue, and a number of all selected tasks to be executed does not exceed the target number;
extract selected tasks to be executed from the task scheduling queue and add the selected tasks to be executed to the task execution queue.

15. The task scheduling device according to claim 14, wherein the selector is further configured to:
select the task scheduling queue that ranks first in the queue scheduling order as the current task scheduling queue;
if the target number does not exceed a maximum single task extraction number of the current task scheduling queue, and a sum of the number of tasks to be executed extracted from the current task scheduling queue to the task execution queue and the target number does not exceed the maximum number of tasks to be executed that can be extracted from the current task scheduling queue to the task execution queue, select the target number of tasks to be executed from the current task scheduling queue as the selected tasks to be executed;
if the target number exceeds the maximum number of tasks extracted from the current task scheduling queue at a time, and a sum of the number of tasks in storage that have been extracted from the current task scheduling queue to the task execution queue and the target number exceeds the maximum number of tasks in storage corresponding to the current task scheduling queue, use a next task scheduling queue as the current task scheduling queue according to the queue scheduling order;
if the target number does not exceed the maximum number of tasks extracted from the current task scheduling queue at a time, and the sum of the number of tasks in storage and the target number of tasks to be executed extracted from the current task scheduling queue to the task execution queue does not exceed the maximum number of tasks in storage that can be extracted from the current task scheduling queue to the task execution queue, perform selecting the target number of tasks to be executed from the current task scheduling queue until the current task scheduling queue is the task scheduling queue at an end of the queue scheduling order.

16. The task scheduling device according to claim 14, wherein the selector is further configured to:
select the task scheduling queue that ranks first in the queue scheduling order as the current task scheduling queue;
if the target number exceeds the single maximum task extraction number of the current task scheduling queue, and the number of tasks in storage of the tasks to be executed that have been extracted from the current task scheduling queue to the task execution queue does not exceed the maximum number of tasks in storage that the current task scheduling queue can extract to the task execution queue, calculate a first difference between the number of tasks in storage and the maximum number of tasks in storage of the current task scheduling queue, determine a smaller number from the first difference and the single maximum task extraction number of the current task scheduling queue as the extraction number of tasks to be executed selected from the current task scheduling queue, and take the next task scheduling queue as the current task scheduling queue according to the queue scheduling order;
if the target number exceeds the maximum number of tasks extracted from the current task scheduling queue at a time, and the number of tasks to be executed that have been extracted from the current task scheduling queue to the task execution queue is greater than or equal to the maximum number of tasks that can be extracted from the current task scheduling queue to the task execution queue, according to the queue scheduling order, use the next task scheduling queue as the current task scheduling queue;
obtain a second difference between the target number and the extraction number, and update the target number to the second difference;
return to execute if the target number exceeds the maximum single task extraction number of the current task scheduling queue, wherein the number of tasks in storage that have been extracted from the current task scheduling queue to the task execution queue does not exceed the maximum number of tasks in storage that the current task scheduling queue can extract to the task execution queue, calculate the first difference between the number of tasks in storage and the maximum number of tasks in storage in the current task scheduling queue, determine the smaller number from the first difference and the maximum single task extraction number of the current task scheduling queue as the extraction number of tasks to be executed selected from the current task scheduling queue, take the next task scheduling queue as the current task scheduling queue according to the queue scheduling order, until the current task scheduling queue is the task scheduling queue at an end of the queue scheduling order.

17. The task scheduling device according to claim 14, wherein the task scheduling device is further configured to:
detect an actual processing delay of each of the tasks to be executed, wherein the actual processing delay being a difference between a time when the task to be executed is added to the task scheduling queue and a time when the task to be executed is completed;
obtain the expected processing delay corresponding to each task scheduling queue;
update a maximum number of tasks in storage corresponding to each task scheduling queue according to the actual processing delay and an expected processing delay corresponding to each task scheduling queue.

18. The task scheduling device according to claim 17, wherein the task scheduling device is further configured to:
set the maximum processing delay of each task scheduling queue according to the expected processing delay of each task scheduling queue;
determine a number of timeout tasks corresponding to each scheduling task queue in a latest monitoring cycle, wherein the timeout task is a task whose actual processing delay exceeds the maximum processing delay of the scheduling task queue;
determine a target task scheduling queue whose execution priority level is greater than a preset level;
if a ratio of the number of tasks in the target scheduling task queue in the latest monitoring cycle to a total number of all tasks to be executed from the target scheduling task queue and completed in the processing exceeds a preset maximum ratio, then increase the maximum number of tasks in storage corresponding to the target task scheduling queue, wherein an increased maximum number of tasks in storage does not exceed the single maximum number of tasks extracted corresponding to the target task scheduling queue.

19. A terminal device, comprising:
a memory configured to store a computer program;
a processor configured to perform a task scheduling method comprising:
obtaining several task scheduling queues of a terminal, wherein one task scheduling queue corresponds to storing a task to be executed of a task type in the terminal, and different task scheduling queues store different task types of tasks to be executed;
determining a queue scheduling order of each task scheduling queue when scheduling tasks to be executed into a task execution queue according to an execution priority of each task type;
obtaining the task execution queue, wherein the task execution queue comprises the tasks to be executed extracted from the task scheduling queues;
if a current queue depth of the task execution queue is less than a maximum queue depth of the task execution queue, calculating a target number of tasks to be executed that can be added to the task execution queue;
selecting the tasks to be executed from the task scheduling queues and adding the tasks to be executed to the task execution queue according to the queue scheduling order and the target number;
taking out the tasks to be executed from the task execution queue for processing.

20. (canceled)

21. The terminal device according to claim 19, wherein before obtaining the several task scheduling queues of the terminal, the task scheduling method further comprises:
creating each of the task scheduling queues;
when the terminal generates the task to be executed, determining the task type of the task to be executed;
according to the task type of the task to be executed, storing a generated task to be executed in a corresponding task scheduling queue.
